(19) United States
(12) Patent Application Publication
(10) Pub. No.: US 2025/0381740 A1
(43) Pub. Date: Dec. 18, 2025

(54) HEATER POWER CONTROL SYSTEM AND METHOD FOR PIPE FUSION APPARATUS

(71) Applicant: MCELROY MANUFACTURING, INC., Tulsa, OK (US)

(72) Inventors: William Paul Goodman, Jenks, OK (US); Todd Ray Strope, Tulsa, OK (US); Paul John Donaldson, Broken Arrow, OK (US); Seth Pelsue Ahrens, Tulsa, OK (US)

(21) Appl. No.: 19/233,104

(22) Filed: Jun. 10, 2025

Related U.S. Application Data
(60) Provisional application No. 63/659,414, filed on Jun. 13, 2024.

(51) Int. Cl. B29C 65/00; B29C 65/30; F02B 63/04; H02P 9/10; H02P 101/25; H05B 1/02

(52) U.S. Cl. CPC B29C 66/95; B29C 65/30; B29C 66/5221; F02B 63/04; H02P 9/107; H05B 1/0227; H02P 2101/25

(57) ABSTRACT

A power control system and method for managing power usage in a pipe fusion apparatus wherein the system and method prevent the engine of the apparatus from stalling in overload conditions, even when using a fusion heater configured for heating pipes over the entire OD fusion range of the fusion apparatus, so that a smaller engine of optimum size can be used.

### RELATED CASE

This application claims the benefit of U.S. Provisional Patent Application No. 63/659,414 filed Jun. 13, 2024, and incorporates the provisional application herein by reference in its entirety as if fully set forth at this point.

### FIELD OF THE INVENTION

The present invention relates to systems and methods for (a) managing and controlling the electrical power usage of the heaters used in pipe fusion apparatuses for heating the ends of the pipe and (b) operating and controlling pipe fusion apparatuses powered by internal combustion engines to prevent the engines from stalling under load conditions.

### BACKGROUND OF THE INVENTION

Butt fusion machines and process are used for permanently joining together lengths of pipe formed of polyethylene or other thermoplastic materials. The fusion process for joining the ends of two pipe sections typically comprises the steps of: (1) using a facer to plane the adjacent ends of the two pipe sections so that they are square and parallel to each other; (2) heating the adjacent ends of the pipe sections to a prescribed fusion temperature; (3) pressing the molten ends of the pipe sections together at a prescribed pressure for a predetermined time to bond the ends of the pipe sections together, and then (4) allowing the fused joint to cool for a prescribed amount of time before releasing the applied pressure.

A pipe fusion machine for performing the butt fusion process will typically comprise: (a) one or more fixed jaws (i.e., one or more, preferably a pair, of pipe clamps) which are mounted in fixed position on a frame or platform for holding a first section of pipe; (b) one or more movable jaws (i.e., one or more, preferably a pair, of pipe clamps) for holding a second section of pipe and moving the end of the second section of pipe toward and away from the first section of pipe; (c) a carriage on which the movable jaws are mounted for carrying the movable jaws longitudinally toward and away from the fixed jaws; (d) a facer which is removably positionable in the fusion zone of the apparatus for removing material from the adjacent ends of the two pipes so that they are square and parallel; and (e) an electric heater which is also removably positionable in the fusion zone for heating the ends of the pipe sections to a molten state for the fusion process.

Although other power systems can alternatively be used for at least some applications, the pipe fusion apparatus will typically include a hydraulic power system which provides the force necessary for pressing the molten ends of the pipe sections together during the fusion process.

The facer and the heater can be pivoting structures that may be swung or rotated into position between the adjacent ends of the pipe sections and then rotated out of the way when not in use. The facer will typically include three or four blades on each side thereof for truing or “facing” the ends of the pipe sections. The heater will typically comprise electric heating elements disposed between two circular heating plates which are simultaneously contacted by the opposing ends of the pipe sections.

Pipe fusion machines can be self-propelled apparatuses, or can be non-driven apparatuses which are towed behind other vehicles or are small enough to be pulled by hand. Many pipe fusion machines include internal combustion engines which (i) power the hydraulic system of the apparatus and (ii) drive an AC alternator which generates electrical power for use by the electric heater and for other purposes. For a self-propelled pipe fusion machine, the wheels or tracks of the apparatus can also be driven by the internal combustion engine.

A disadvantage of some pipe fusion machines heretofore used in the art is that it has been necessary to replace the electric heater used in the apparatus when fusing pipes of different sizes. This is because the size and configuration of each heater has only been suitable for fusing pipes within a relatively narrow diameter range. Consequently, when switching from the fusion of small diameter pipes to the fusion of larger diameter pipes, it has been necessary to first replace the electric heater.

In one aspect of the present invention, a new heater is used in the butt fusion machine which is operable for heating and fusing pipes over a wide range of sizes so that the heater need not be replaced when switching from the fusion of small diameter pipes to the fusion of larger diameter pipes, or vice versa. The new electric heater will preferably be sized and configured to cover the entire pipe OD fusion range of the carriage of the pipe fusion machine.

In order to accommodate such a wide range of pipe diameters, the width of the heated contacting area of the new heater has been significantly increased. However, this has also significantly increased the amount of electrical power required by the heater. By way of example, but not by way of limitation, whereas the prior replaceable heaters used for heating a narrow range of smaller pipes or a narrow range of larger pipes might have each typically required about 3,000 watts of electrical power to operate effectively, the heater preferred for use in the present invention, which is configured for heating and fusing pipes over a much broader pipe OD range (e.g., a pipe OD range of from 6 to 18 inches), might typically require about 4,300 watts.

Unfortunately, the increased power requirement of the electric heater also increases the demand on the internal combustion engine of the fusion machine. Thus, without significantly increasing the size and the cost of the internal combustion engine, the engine can become overloaded and stall under certain operating conditions.

As the RPM of an internal combustion engine increases, the torque v. RPM curve of the engine will typically (i) curve upwardly until a maximum available torque point is reached and then (ii) curve downwardly from the maximum available torque point as the RPM of the engine continues to increase. When an internal combustion engine is loaded to a point that requires more torque than the engine can supply when operating at a given RPM, it causes the engine to slow down, which in turn changes the amount of available torque as determined by the torque v. RPM curve of the engine.

Consequently, when selecting an internal combustion engine for a given application, the size, power, and torque curve of the engine will preferably be specified such that the intended operating range of the engine for the application in question will be on the downwardly curved portion of the torque v. RPM curve following the maximum torque point. The reason being that this allows the engine to at least initially provide increased available torque under high loading conditions in which the RPM (speed) of the engine is caused to decrease.

The increased available torque provided in such situations allows the engine to recover and return to the desired operating range. On the other hand, if the engine becomes overloaded and slows to the extent that it moves back past the maximum torque point so that the available torque is now decreasing as the speed of the engine continues to decline, it will cause the engine to stall.

When using the new electric heater in the pipe fusion machine, because of the size of the increased load which is placed on the internal combustion engine whenever the new electric heater is drawing power, there are circumstances in which the engine can become overloaded and will be likely to stall. By way of example, but not by way of limitation, the engine can become significantly overloaded and may stall when the temperature controller for the heater turns the heater on while (a) the operator is skid turning, (b) the machine is driving up a steep grade, or (c) the operator fully strokes the hydraulics for the carriage. Moreover, the likelihood of stalling the engine will be even greater when operating in high temperature conditions and/or at high altitude.

The engines, below a certain power rating, used in pipe fusion machines are entirely mechanically governed so that there is no means to control the engine electronically and there are no sensors to measure the load and speed of the engine. Consequently, for a pipe fusion machine using the new heater, there is no means for managing power usage or engine loads in overload situations such as those mentioned above in order to prevent the engine from stalling. Nor is there any means for monitoring engine speed, torque utilization, and changes in loading conditions in a manner effective for controlling and managing power loads.

### SUMMARY OF THE INVENTION

The present invention resolves the problems and satisfies the needs mentioned above. In one aspect, there is provided a heater control system, preferably comprising a heater control module, for a pipe fusion apparatus which is driven by an internal combustion engine. The heater control system measures and monitors the output frequency of an AC alternator which is driven by the engine for providing electrical power. The heater control system then uses a linear relationship between the output frequency of the alternator and the RPM of the internal combustion engine to determine whether the engine is approaching or is in an overload/stall condition. If so, the heater control system shuts off or reduces the electric power to the heater.

In another aspect, there is provided a method of managing power and preventing stalling conditions in a pipe fusion apparatus which (i) is powered by an internal combustion engine and (ii) includes an AC alternator which is also driven by the engine to provide electrical power for a fusion heater, and possibly for other purposes. The method comprises the steps of (a) determining and monitoring the output frequency of the alternator, (b) using a linear relationship between the output frequency of the alternator and the RPM of the internal combustion engine to determine whether the engine is approaching or in an overload/stall condition, and if so (c) shutting off or reducing the electrical power to the heater.

In another aspect there is provided a heater power control system for a pipe fusion apparatus wherein the pipe fusion apparatus includes (i) an AC alternator, (ii) an electric fusion heater which is heated as needed by electrical power generated by the AC alternator to achieve and maintain a temperature of the electric fusion heater, and (iii) an internal combustion engine which powers the AC alternator such that there is a linear relationship between an output frequency of the AC alternator and a RPM of the internal combustion engine.

The heater power control system preferably comprises one or more non-transitory computer storage media having programmed instructions thereon which cause the heater power control system to perform programmed steps of: (a) monitoring the output frequency of the AC alternator; (b) determining if the internal combustion engine is in a torque bog state such that the output frequency of the AC alternator or the RPM of the internal combustion engine is at or below a predetermined torque bog point frequency or RPM; (c) then, if the internal combustion engine is in the torque bog state, shutting off or reducing any flow of the electrical power to the electric fusion heater and disabling an automatic heater control of the heater power control system from beginning any flow, or increasing any flow, of the electrical power to the electric fusion heater; (d) determining if the internal combustion engine has recovered from the torque bog state; and (e) then, if the internal combustion engine has recovered from the torque bog state, enabling the automatic heater control to again begin or increase a flow of the electrical power to the electric fusion heater as needed to achieve and maintain the temperature of the electric fusion heater.

In another aspect, there is provided a method of managing power usage and engine overload conditions in a pipe fusion apparatus wherein the pipe fusion apparatus includes (i) an AC alternator, (ii) an electric fusion heater which is heated as needed by electrical power generated by the AC alternator to achieve and maintain a temperature of the electric fusion heater, and (iii) an internal combustion engine which powers the AC alternator such that there is a linear relationship between an output frequency of the AC alternator and a RPM of the internal combustion engine.

The method preferably comprises the steps of automatically: (a) monitoring the output frequency of the AC alternator; (b) determining if the internal combustion engine is in a torque bog state such that the output frequency of the AC alternator or the RPM of the internal combustion engine is at or below a predetermined torque bog point frequency or RPM; (c) then, if the internal combustion engine is in the torque bog state, shutting off or reducing any flow of the electrical power to the electric fusion heater and disabling the flow of the electrical power to the electric fusion heater from being restarted or increased; (d) determining if the internal combustion engine has recovered from the torque bog state; and (e) then, if the internal combustion engine has recovered from the torque bog state, re-enabling the flow of the electrical power to the electric fusion heater to be restarted or increased as needed to achieve and maintain the temperature of the electric fusion heater.

The inventive heater control system and method eliminate the need to install a larger engine in the pipe fusion apparatus in order to prevent engine overload conditions resulting from the increased power usage of the heater. Consequently, the inventive system and method allow the use of an engine which is of optimal size for the application.

Further objects, features, and advantages of the present invention will be apparent to those in the art upon examining the accompanying drawings and upon reading the following Detailed Description Of The Preferred Embodiments.

### BRIEF DESCRIPTION OF THE DRAWINGS

FIG. 1 schematically illustrates an embodiment 2 of a heater control module provided by the present invention.

FIG. 2 is a chart illustrating the operation of the heater control module 2.

FIG. 3 is another chart illustrating the operation of the heater control module 2.

FIG. 4A is a first section of a flow chart illustrating the programmed operation of the heater control module 2.

FIG. 4B is a second section of the flow chart.

FIG. 4C is a third section of the flow chart.

### DETAILED DESCRIPTION OF THE PREFERRED EMBODIMENTS

In the inventive pipe fusion apparatus and method, AC electrical power is preferably generated by an AC alternator which is directly coupled to, and driven by, the internal combustion engine of a pipe fusion machine. The output of the AC alternator preferably goes to a GFCI (Ground Fault Circuit Interrupter) box and then to a power control device 4 which is included in a heater control system provided by the present invention. The power control device 4 delivers and is used to control the flow of the electrical current to the electric heater of the fusion apparatus. The heater used in the pipe fusion apparatus will preferably be a new heater of the type described above which is sized and configured for heating the entire pipe OD range of the carriage of the pipe fusion machine.

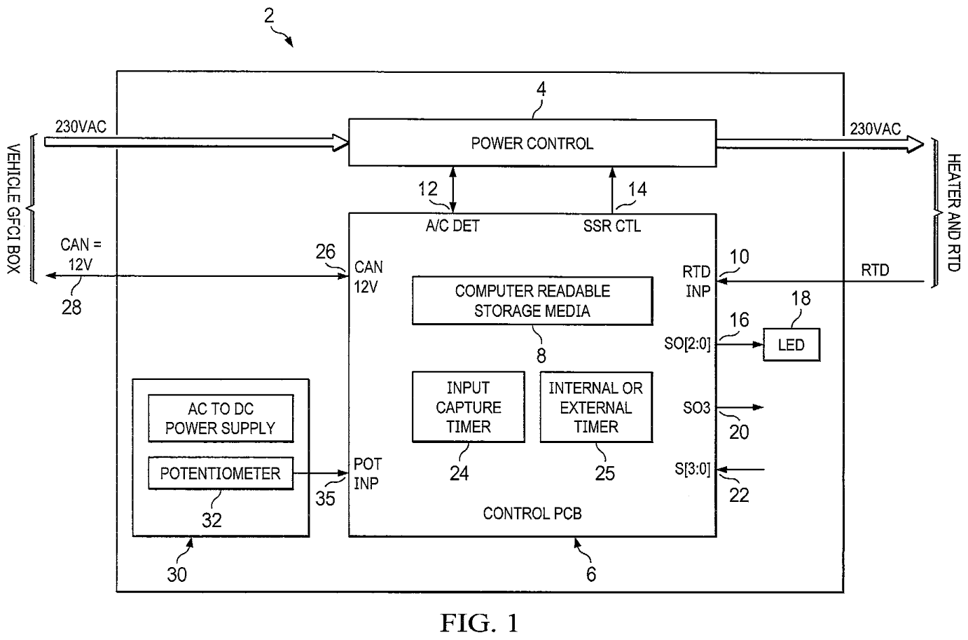

The inventive heater control system preferably comprises a heater control module. An embodiment 2 of the heater control module provided and used in the present invention is illustrated in FIG. 1. The inventive heater control module 2 will preferably be installed and located on the fixed frame or platform of the pipe fusion apparatus, most preferably on the indexer that is located on the jaw carriage skid.

By way of example, but not by way of limitation, the power control device 4 of the heater control module 2 can be (i) a solid state relay which is operated to switch the electrical power to the heater on and off or (ii) a pulse width modulation control device such as a Triac, Mosfet, or similar circuit which is operated to modulate the electrical power to the heater over a power range, preferably the entire power range from and including zero power (off) to and including full power (100%).

The heater control module 2 also includes at least one computer processing unit (CPU) 6, which preferably is or is a part of a printed circuit board (PCB). The PCB or other CPU 6 includes one or more non-transitory computer storage media 8 having programmed instructions thereon which are executable by the CPU 6 for operating the power control device 4 and for performing the other determinations, tasks, and operations of the heater control module 2.

The CPU 6 also comprises an RTD input 10 for receiving a signal from a Resistive Temperature Device (RTD) or other temperature sensor which is used to monitor the temperature of the heater within the pipe fusion apparatus. Pursuant to the programmed instructions stored on the computer readable storage media 8, the PCB or other CPU 6 determines whether the temperature is above or below an operating set point for the heater. If the heater temperature dips below the set point temperature, the CPU 6 will preferably activate the power control device 4 to turn the electrical power to the heater on or increase the power to the heater. If the temperature reaches or exceeds the set point temperature, the CPU 6 will preferably activate the power control device 4 to turn the electrical power to the heater off or reduce the electrical power to the heater.

Additional features of the PCB or other CPU 6 include (a) an AC DET input 12 between the CPU 6 and the power control device 4 which detects, and from which generates a timing pulse for every positive or negative half cycle of the alternator AC waveform, (b) a SSR CTL output 14 from the CPU 6 to the power control device 4 which allows a signal from the CPU 6 to control the SSR output, and (c) a SO0 and SO1 output 16 to an LED 18 which indicates the operating state through either constantly illuminated green or red light, or flashed error/state codes.

The PCB or other CPU 6 further includes an Input Capture Timer (ICT) 24 which receives timing pulses from the AC DET circuit in order to read the output frequency of the AC alternator. Pursuant to the programmed instructions stored on the computer readable storage media 8, the CPU 6 uses the output frequency of the AC alternator to determine the RPM of the internal combustion engine. The engine RPM will be directly proportional to the output frequency of the AC alternator so that if, for example, the alternator is a two-pole alternator which is directly coupled to the engine, the engine RPM can be determined by multiplying the output frequency of the alternator in cycles per second (Hz) times 60 seconds.

Alternatively, rather than calculating RPM, the linear relationship between the alternator output frequency and the RPM of the engine allows the alternator frequency to be used directly in the inventive heater control system and method, e.g., by simply converting the torque v. RPM curve for the engine to a torque v. alternator frequency curve.

Also pursuant to the programmed instructions stored on the computer readable storage media 8, once the alternator output frequency and/or the corresponding RPM of the engine is/are determined, the PCB or other CPU 6 then determines whether the internal combustion engine is approaching an overloaded condition by determining whether the engine frequency or RPM has slowed to a point which is at or below a bog threshold value on the engine torque v. RPM or the engine torque v. frequency curve. The bog threshold is a predetermined frequency or RPM value which is slightly above (preferably within a range of from 5% to 10% above) the frequency or corresponding RPM point at which the engine will stall and not recover.

If the engine has slowed to the bog threshold value or below, the CPU 6 will act in accordance with the programmed instructions stored on the computer readable storage media 8 to signal the power control device 4 to shut off or at least reduce the flow of electrical power to the heater.

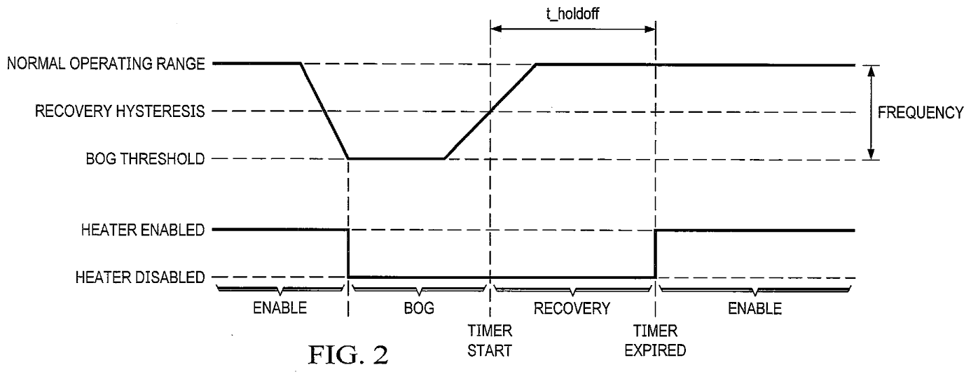

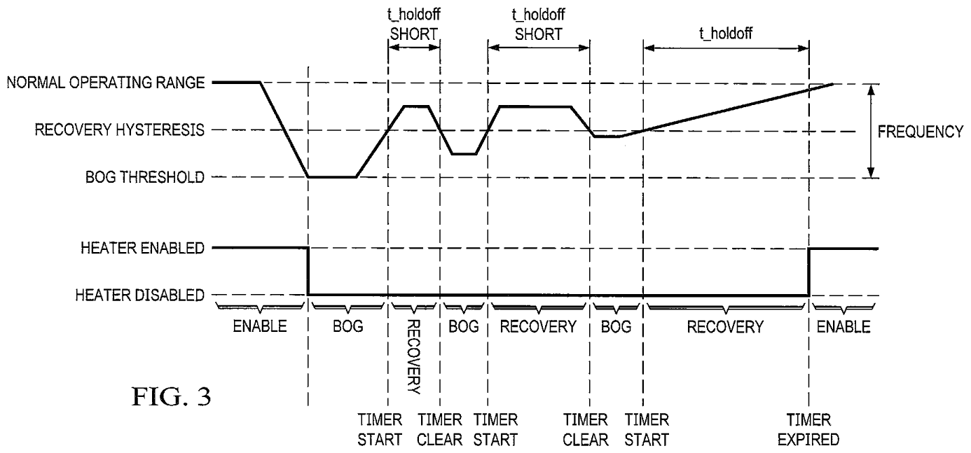

This is illustrated in FIGS. 2 and 3 where the engine is initially operating in a normal RPM or corresponding alternator frequency range such that the automatic heater control is enabled (i.e., the heater temperature control of the CPU 6 is permitted to automatically turn the power to the heater on and off as needed in order to maintain the set temperature for the heater). Then, as also shown in FIGS. 2 and 3, if the load on the engine increases such that the frequency/RPM slows to the bog threshold, the heater control module 2 automatically turns the power to the heater off and disables the automatic heater control of the CPU 6 (i.e., the heater temperature control of the CPU 6 is not permitted to automatically turn the heater back on in order to maintain the set temperature for the heater).

Next, as further illustrated in FIGS. 2 and 3, when the engine RPM subsequently increases to a predetermined recovery hysteresis point, the PCB or other CPU 6 then operates in accordance with the programmed instructions to initiate an internal or external timer 25 for a predetermined full recovery period. The recovery hysteresis point will preferably be in the range of from 1.5% to 5% below available utility power frequencies, such as 50 Hz. If, as illustrated in FIG. 2, the frequency/RPM remains above the recovery hysteresis point for the entire recovery period, then the heater control module 2 operates in accordance with the programmed instructions to re-enable the heater temperature control of the CPU 6 to automatically turn the electrical power to the heater on and off as needed in order to return to and maintain the set temperature of the heater.

On the other hand, as illustrated in FIG. 3, if at any time during the recovery period the frequency/RPM bogs below the recovery hysteresis point, the heater control module 2 will operate in accordance with the programmed instructions to clear the timer 25 and cause the system to start over such that, when the frequency/RPM again increases to the recovery hysteresis point, the timer 25 will be reinitiated for another full recovery period.

If the engine RPM then remains above the recovery hysteresis point for the reinitiated full recovery period, the heater control module 2 will operate in accordance with the programmed instructions to re-enable the heater temperature control of the CPU 6 to automatically turn the electrical power to the heater on and off as needed in order to return to and maintain the set temperature of the heater. But if not, the entire process will be repeated until the frequency/RPM eventually remains above the recovery hysteresis point for a full recovery period.

The PCB or other CPU 6 also includes an input/output 26 for a Control Area Network (CAN) bus 28. The heater control module 2 communicates with a DataLogger® or other instrument via the CAN bus 28 for monitoring and recording the status of the heater and inputting the temperature set point for the heater.

The temperature set points for the heater can alternatively be manually entered by the operator using a manual temperature control 30 which is included in the heater control module 2. The manual control 30 includes (i) a potentiometer 32 with a temperature dial for manually setting the temperature of the heater and (ii) an AC to DC power supply converter 34. The manual temperature control 30 communicates directly with the PCB or other CPU 6 through a potentiometer input 35 of the CPU 6.

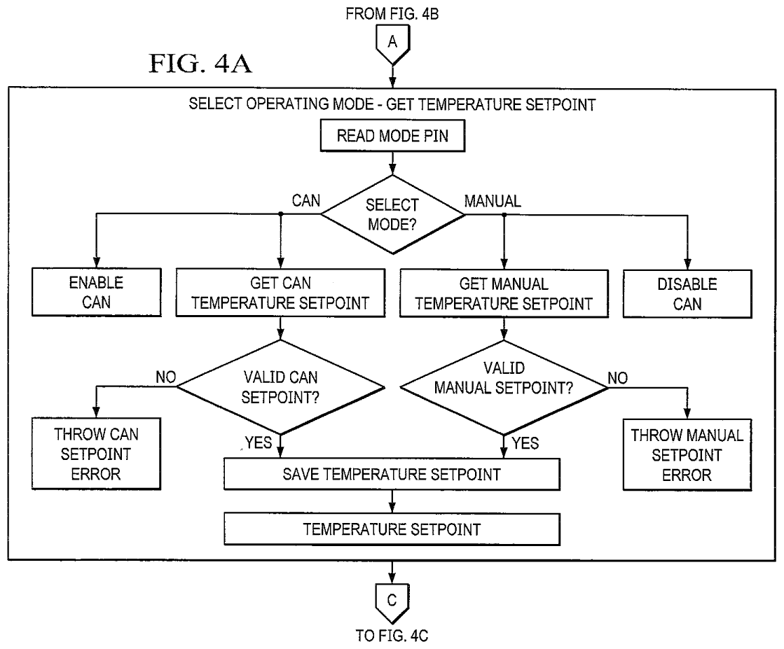

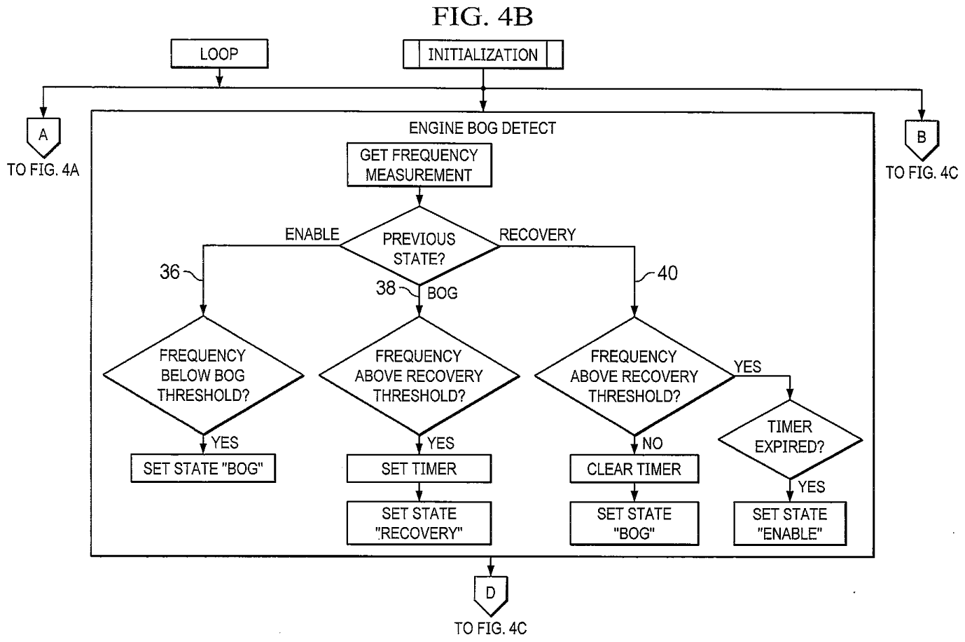

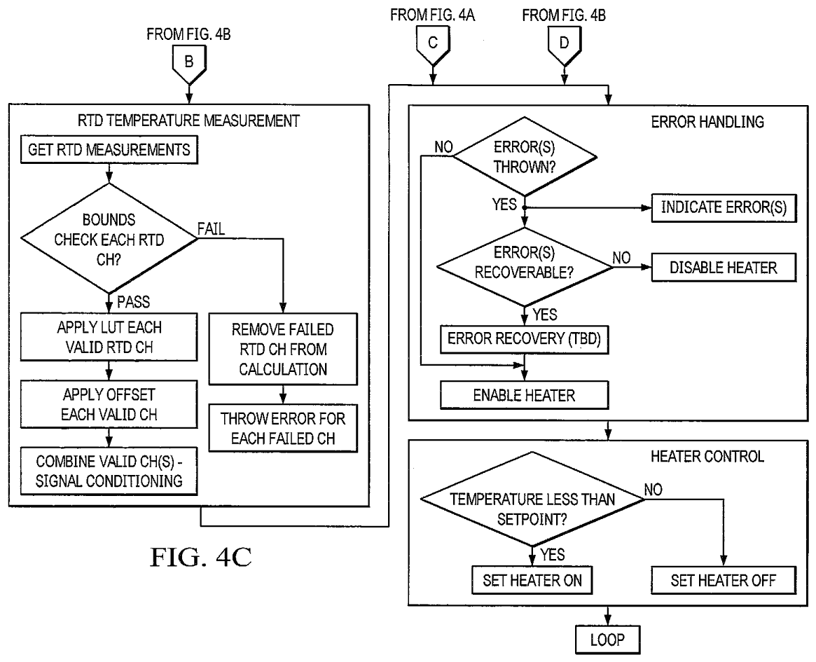

A flow chart for the inventive method performed by the heater control module (HCM) 2, as embodied in the programmed instructions stored on the computer readable storage media 8, is provided in FIG. 4. Using the output frequency of the AC alternator, the HCM 2 can determine the RPM of the engine of the pipe fusion machine. Alternatively, due to the direct linear relationship between the output frequency of the AC alternator and the engine RPM, the HCM 2 can instead use the frequency directly, based upon an engine torque curve which has been converted from torque v. RPM to torque v. alternator frequency. Consequently, although FIG. 4 uses the alternator output frequency directly, it will be understood that the same process flow would also be applicable to the use of the calculated engine RPM.

As seen in the flow chart of FIG. 4, and as also illustrated in the status charts of FIGS. 2 and 3, once the alternator output frequency is determined, the HCM 2 determines whether the heater was previously (is currently) in the enabled state 36, the bog state 38, or the recovery state 40. If in the enabled state 36, the HCM 2 determines whether the frequency is now below the bog threshold. If so, the system is set to the bog state 38 so that the power to the heater is turned off (or at least turned down) and the heater temperature control is prevented from automatically turning the power to the heater back on (or otherwise turns down the maximum allowable power that the temperature control loop can set). If the heater is currently in the bog state 38, the HCM 2 determines whether the frequency or RPM is above the recovery threshold. If so, the system timer 25 is initiated to begin the recovery period and the system is set to the recovery state 40.

If the heater is currently in the recovery state 40, the HCM 2 determines whether the frequency or RPM is still above the recovery threshold (the recovery hysteresis point). If not, the HCM 2 clears the timer 25 and resets the system to the bog state 38. But if the frequency or RPM is still above the recovery threshold, the HCM 2 determines whether the timer recovery period has expired. If it has, the HCM 2 resets the system to the enabled state 36 and permits the heater temperature control of the CPU 6 to automatically either turn the power to the heater back on or increase the power to the heater as needed in order to return to and maintain the set temperature of the heater.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within the invention.

What is claimed is:

1. A heater power control system for a pipe fusion apparatus wherein the pipe fusion apparatus includes (i) an AC alternator, (ii) an electric fusion heater which is heated as needed by electrical power generated by the AC alternator to achieve and maintain a temperature of the electric fusion heater, and (iii) an internal combustion engine which powers the AC alternator such that there is a linear relationship between an output frequency of the AC alternator and a RPM of the internal combustion engine, the heater power control system comprising one or more non-transitory computer storage media having programmed instructions thereon which cause the heater power control system to perform programmed steps of:
a) monitoring the output frequency of the AC alternator;
b) determining if the internal combustion engine is in a torque bog state such that the output frequency of the AC alternator or the RPM of the internal combustion engine is at or below a predetermined torque bog point frequency or RPM;
c) then, if the internal combustion engine is in the torque bog state, shutting off or reducing any flow of the electrical power to the electric fusion heater and disabling an automatic heater control of the heater power control system from beginning any flow, or increasing any flow, of the electrical power to the electric fusion heater;
d) determining if the internal combustion engine has recovered from the torque bog state; and
e) then, if the internal combustion engine has recovered from the torque bog state, enabling the automatic heater control to again begin or increase a flow of the electrical power to the electric fusion heater as needed to achieve and maintain the temperature of the electric fusion heater.

2. The heater power control system of claim 1 further comprising the predetermined torque bog point frequency or RPM being above a torque stall point frequency or RPM for the internal combustion engine.

3. The heater power control system of claim 1 further comprising, in step (d), the heater power control system operating in accordance with the programmed instructions to determine if the output frequency or the RPM is at or above a predetermined torque recovery threshold frequency or RPM for the internal combustion engine.

4. The heater power control system of claim 3 further comprising the predetermined torque recovery threshold frequency or RPM being (i) above the predetermined torque bog point frequency or RPM and (ii) below a normal torque operating frequency or RPM range of the internal combustion engine.

5. The heater power control system of claim 3 further comprising, in step (d), the heater power control system also operating in accordance with the programmed instructions to determine if the output frequency or the RPM has continuously remained at or above the predetermined torque recovery threshold frequency or RPM for a predetermined full recovery period.

6. The heater power control system of claim 1 further comprising, in step (d), the heater power control system operating in accordance with the programmed instructions to determine if the internal combustion engine has recovered from the torque bog state by:
determining if the output frequency or the RPM has increased to a point that is at or above a predetermined torque recovery threshold frequency or RPM;
then, if the output frequency or the RPM has increased to a point that is at or above the predetermined torque recovery threshold frequency or RPM, setting a timer for a predetermined full recovery period;
then determining whether the output frequency or the RPM has remained at or above the predetermined torque recovery threshold frequency or RPM wherein
if the output frequency or the RPM has remained at or above the predetermined torque recovery threshold frequency or RPM and the predetermined full recovery period has expired, the heater power control system proceeds to step (e) to enable the automatic heater control to again begin or increase the flow of the electrical power to the electric fusion heater as needed to achieve and maintain the temperature of the electric fusion heater, or
if the output frequency or the RPM has remained at or above the predetermined torque recovery threshold frequency or RPM but the predetermined full recovery period has not expired, the heater power control system does not yet proceed to step (e), or
if the output frequency or the RPM has fallen below the predetermined torque recovery threshold frequency or RPM and the predetermined full recovery period has not expired, the heater power control system clears the timer.

7. The heater power control system of claim 6 further comprising in step (d), in accordance with the programmed instructions, if the output frequency or the RPM did not remain at or above the predetermined torque recovery threshold frequency or RPM for the predetermined full recovery period and the heater power control system has cleared the timer, the heater power control system then redetermines whether the output frequency or the RPM has again increased to a point that is at or above the predetermined torque recovery threshold frequency or RPM and, if so, the heater power control system resets the timer for the predetermined full recovery period.

8. The heater power control system of claim 1 further comprising the electric fusion heater being sized and configured for heating pipes of any outside diameter over an entire pipe OD fusion range of the pipe fusion apparatus.

9. The heater power control system of claim 8 further comprising the entire pipe OD fusion range of the pipe fusion apparatus extending from and including a pipe OD of as small as 6 inches to and including a pipe OD of as large as 18 inches.

10. A method of managing power usage and engine overload conditions in a pipe fusion apparatus wherein the pipe fusion apparatus includes (i) an AC alternator, (ii) an electric fusion heater which is heated as needed by electrical power generated by the AC alternator to achieve and maintain a temperature of the electric fusion heater, and (iii) an internal combustion engine which powers the AC alternator such that there is a linear relationship between an output frequency of the AC alternator and a RPM of the internal combustion engine, the method comprising steps of automatically:
a) monitoring the output frequency of the AC alternator;
b) determining if the internal combustion engine is in a torque bog state such that the output frequency of the AC alternator or the RPM of the internal combustion engine is at or below a predetermined torque bog point frequency or RPM;
c) then, if the internal combustion engine is in the torque bog state, shutting off or reducing any flow of the electrical power to the electric fusion heater and disabling the flow of the electrical power to the electric fusion heater from being restarted or increased;
d) determining if the internal combustion engine has recovered from the torque bog state; and
e) then, if the internal combustion engine has recovered from the torque bog state, re-enabling the flow of the electrical power to the electric fusion heater to be restarted or increased as needed to achieve and maintain the temperature of the electric fusion heater.

11. The method of claim 10 further comprising the predetermined torque bog point frequency or RPM being above a torque stall point frequency or RPM for the internal combustion engine.

12. The method of claim 10 further comprising, in step (d), automatically determining if the output frequency or the RPM is at or above a predetermined torque recovery threshold frequency or RPM for the internal combustion engine.

13. The method of claim 12 further comprising the predetermined torque recovery threshold frequency or RPM being (i) above the predetermined torque bog point frequency or RPM and (ii) below a normal torque operating frequency or RPM range of the internal combustion engine.

14. The method of claim 12 further comprising, in step (d), automatically determining if the output frequency or the RPM has continuously remained at or above the predetermined torque recovery threshold frequency or RPM for a predetermined full recovery period.

15. The method of claim 10 further comprising, in step (d), automatically determining if the internal combustion engine has recovered from the torque bog state by:
determining if the output frequency or the RPM has increased to a point that is at or above a predetermined torque recovery threshold frequency or RPM;
then, if the output frequency or the RPM has increased to a point that is at or above the predetermined torque recovery threshold frequency or RPM, setting a timer for a predetermined full recovery period;
then determining whether the output frequency or the RPM has remained at or above the predetermined torque recovery threshold frequency or RPM wherein
if the output frequency or the RPM has remained at or above the predetermined torque recovery threshold frequency or RPM and the predetermined full recovery period has expired, the method proceeds to step (e) to re-enable the flow of the electrical power to the electric fusion heater to be restarted or increased as needed to achieve and maintain the temperature of the electric fusion heater, or
if the output frequency or the RPM has remained at or above the predetermined torque recovery threshold frequency or RPM but the predetermined full recovery period has not expired, the method does not yet proceed to step (e), or
if the output frequency or the RPM has fallen below the predetermined torque recovery threshold frequency or RPM and the predetermined full recovery period has not expired, the timer is cleared and the method does not proceed to step (e).

16. The method of claim 15 further comprising, in step (d), if the output frequency or the RPM did not remain at or above the predetermined torque recovery threshold frequency or RPM for the predetermined full recovery period and the timer has been cleared, redetermining whether the output frequency or the RPM has again increased to a point that is at or above the predetermined torque recovery threshold frequency or RPM and, if so, resetting the timer for the predetermined full recovery period.

17. The method of claim 10 further comprising the electric fusion heater being sized and configured for heating pipes of any outside diameter over an entire pipe OD fusion range of the pipe fusion apparatus.

18. The method of claim 17 further comprising the entire pipe OD fusion range of the pipe fusion apparatus extending from and including a pipe OD of as small as 6 inches to and including a pipe OD of as large as 18 inches.
